(19) United States
(12) Patent Application Publication
(10) Pub. No.: US 2025/0123500 A1
(43) Pub. Date: Apr. 17, 2025

(54) BLUE-LIGHT REGULATING EYEWEAR FOR SUPPORTING HEALTHY CIRCADIAN RHYTHMS AND PROVIDING EYE PROTECTION THROUGHOUT DAYTIME AND NIGHTTIME HOURS

(71) Applicant: CircadianEye, LLC, Stoneham, MA (US)

(72) Inventor: Andrew Schmeder, Stoneham, MA (US)

(21) Appl. No.: 18/886,298

(22) Filed: Sep. 16, 2024

Related U.S. Application Data
(60) Provisional application No. 63/589,984, filed on Oct. 12, 2023.

(51) Int. Cl. G02C 7/10

(52) U.S. Cl. CPC G02C 7/104

(57) ABSTRACT

A method for improving human circadian health and protecting the eyes from high-energy visible blue light while performing activities during daytime and nighttime hours wherein an eyewear device is selected and positioned in front of the eyes of a person such that the lenses of the eyewear device substantially filter the light received by the eyes. In some variations, the lenses of the selected eyewear device for use during daytime hours provide eye protection from high-energy visible blue light and provide a transmittance of circadian blue light that is between 100 percent to 150 percent relative to the luminous transmittance of the lenses. In some variations, the lenses of the selected eyewear device for use during nighttime hours provide a transmittance of circadian blue light that is less than 40 percent, or less than 25 percent, or less than 15 percent relative to the luminous transmittance of the lenses.

### CROSS-REFERENCE TO RELATED APPLICATIONS

The present invention claims priority to provisional application 63/589,984 filed Oct. 12, 2023 which is hereby incorporated in its entirety at least by reference.

### BACKGROUND OF THE INVENTION

### 1. Field of the Invention

The present invention relates generally to the field of ophthalmic optics and, more particularly, to lenses designed to reduce the transmittance of specific wavelengths of light. The methods of the invention relate to using lenses with selective transmittance of one or more sub-bands of visible light to optimize the retinal exposure to blue light to support healthy circadian rhythms, to improve alertness, and to provide eye protection from high-energy visible blue light.

### 2. Description of Related Art

The presence of a light-sensitive mechanism responsible for synchronization of twenty-four hour periodic processes in biological organisms was first hypothesized by researcher Clyde E. Keeler in 1927. In 1959, German biologist Franz Halberg coined the word “circadian” from the Latin words “circa”, meaning “about” and “dies”, meaning “day”, which was thereafter adopted by the medical community to describe the entrainment of biological processes in organisms to the approximately 24-hour cycle of night and day. In 2002, the intrinsically photosensitive retinal ganglion cell (the ipRGC), a photo-sensitive cell found in the human retina, was proven to be responsible for the entrainment of human circadian rhythms to the 24-hour daily cycle of light and dark from natural sunlight. The pigment responsible for capturing light in the ipRGC is melanopsin, and it is expressed by the OPN4 gene. Melanopsin is known from in-vitro analysis to have a peak absorption of approximately 480 nanometers and a full-width half-maximum of approximately 100 nanometers, with its spectral sensitivity generally including wavelengths of light between 400 nanometers to 550 nanometers.

Optical filters that attenuate some or all light between 400 nanometers and 550 nanometers are known to have physiological effects when used at night to filter the light reaching the eye of a human person, including reduction of stress, improved sleep and reducing disruption to normal circadian rhythms caused by exposure to artificial light at night. Eyewear devices comprising spectral filters that reduce transmittance of light between 400 nanometers to 550 nanometers, and methods of using such eyewear devices, have been disclosed in patent literature since at least 1982 and continue to be an area of innovation today.

U.S. Pat. No. 4,952,046At by Stephens et al filed 1982 Feb. 26 provides a spectacle lens worn in front of the eyes of humans in outdoor sunlit environment comprising a sharp cut-on orange dye that allows the lens to transmit at least 90% of the visible sunlight with wavelengths longer than 636 nanometers and blocks 99% or more of all sunlight with wavelength shorter than 515 nanometers. Embodiments of the orange dye include Color Index Dispersed Orange Dye 3. In some embodiments the cut-on wavelength is between 515 nanometers to 550 nanometers, which varies depending on the optical density of the dye component.

U.S. Pat. Nos. 5,177,509A and 5,400,175 both by Johansen et al. filed 1987 Feb. 26 discloses a lens that combines a polarizing filter with a cut-on filter wherein the cut-on filter is selected to cut-on at 450 nanometers, 500 nanometers, 515, 530 or 550 nanometers. The inventors note that a “beneficial and calming effect” is obtained by wearing blue-light blocking glasses, and that “wearing blue blocking glasses may result in an increased release of melatonin from the pineal.”

U.S. Pat. No. 5,274,403A by Gott filed 1987 Aug. 28 provides a lens for inhibiting the production of melatonin comprising a band-pass filter substantially having a band peak transmittance at about 509 nanometers and a half-maximum bandwidth of 100 nanometers.

U.S. Pat. No. 5,235,358A by Mutzhas et. al. filed 1988 Nov. 8 discloses a light filter formed of plastic and a dye providing a cut-on filter having a cut-on wavelength between 450 nanometers to 550 nanometers and a cut-on steepness of at least 1% per nanometer.

EP0436516A2 by Wilkinson et all filed 1990 Jan. 4 provides optical devices that attenuate wavelengths of light to reduce photophobia. The inventors describe a transmission spectrum blocking approximately 90% of light at wavelengths shorter than 500 nanometers, and a gradual slope of increasing transmission from 500 nanometers to 600 nanometers.

U.S. Pat. No. 5,083,858A by Girerd filed 1989 Apr. 7 discloses improved sunglasses that maximize the stimulation of human rhodopsin by selectively filtering the wavelengths of light so that light of 490 nanometers (corresponding to the peak sensitivity of the melatonin-responsive ipRGC system) and having a pass band centered substantially at that wavelength and substantially attenuating light at wavelengths outside the passband. The glasses improve stimulation of the circadian system during daylight hours. In some embodiments a green solvent dye is incorporated into a lens by immersion of the lens in a dye bath solution comprising one or more solvents and the dye.

U.S. Pat. No. 5,402,190A by Waldman filed 1991 Oct. 16 discloses goggles with a selective light attenuation blocking substantially all wavelengths of light between 480 nanometers to 520 nanometers.

U.S. Pat. No. 5,381,193A by Wedding filed 1993 Feb. 22 discloses a photochromic lens for protecting the eye from the effects of strong sunlight wherein the lens combines a blue-light filtering function blocking substantially all light from 400 nanometers to 550 nanometers, in combination with a photochromic glass providing a transmittance that darkens under exposure to ultraviolet radiation.

U.S. Pat. No. 6,350,275B1 by Verman et. al. filed 1997 Jun. 9 discloses a spectacle eyewear device for treatment of circadian rhythm disorders using light emitting diodes positioned around the perimeter of the lens and directing light toward the eyes of the wearer.

U.S. Pat. No. 10,213,619B2 by Brainard et al filed 2000 May 10 claims a lighting apparatus for reducing the stimulation of the intrinsically photosensitive retinal ganglion cells comprising an optical filter that substantially attenuates light emitted between 435 nanometers to 488 nanometers while substantially transmitting light outside of said blocking band.

U.S. Pat. No. 6,955,430B2 by Pratt filed 2001 Dec. 11 discloses an eyewear article that partially attenuates blue light between 400 nanometers to 510 nanometers and the lens comprises lutein.

U.S. Pat. No. 7,748,845B2 by Casper et al. filed 2002 Aug. 28 discloses a method for maintaining circadian rhythm of a subject comprising substantially blocking retinal exposure to light of wavelengths less than 490 nanometers and allowing transmission of more than 40 percent of non-blocked wavelengths of light.

U.S. Pat. No. 8,360,574B2 by Ishak et. al. filed 2006 Mar. 20 provides lenses with selective filters that partially attenuate certain wavelengths of light with a wavelength less than 450 nanometers and transmit at least 80% of light in the range of 460 nanometers to 700 nanometers.

U.S. Pat. No. 7,520,607B2 by Casper et al. filed 2002 Sep. 28 describes a device for inhibiting melatonin suppression comprising a lens (or similar means) for selectively blocking more than 50 percent light with wavelengths less than or at 530 nanometers, while transmitting more than 50 percent of non-blocked wavelengths of light. The disclosure also provides a method of using said device and variations over the means of filtering such as a light cover and a spectacle lens.

U.S. Pat. No. 9,750,918B2 by Casper et. al. filed 2013 Apr. 11 discloses a method for improving sleep performance by exposing the subject to artificial light that causes poor sleep performance, and then improving sleep by selectively substantially blocking retinal exposure of the subject to light of wavelengths less than 490 nanometers.

U.S. Pat. No. 6,926,405B2 by Ambler et. al filed 2003 Jun. 6 discloses an eyewear lens having a selective spectral response comprising a partial attenuation of light of wavelengths below 450 nanometers in combination with a photochromic dye capable of darkening the lens upon exposure to sunlight. The inventors describe the device as being particularly useful for persons while driving a car during daylight hours.

U.S. Pat. No. 8,164,844B2 by Todo et. al. filed 2005 Mar. 16 discloses an optical filter and a lighting device for preventing the suppression of melatonin secretion wherein the optical filter comprises a reduced transmittance between 480 to 505 nanometers, and between 425 to 445 nanometers, and between 535 to 565 nanometers, and a relatively greater transmittance at wavelengths at other visible wavelengths.

U.S. Pat. No. 8,113,651B2 by Blum et. al. filed 2006 Mar. 20 describes ophthalmic devices comprising a spectral filter that absorbs more than 50 percent of light having wavelengths between 400 nanometers and 460 nanometers, and transmits a greater amount of light of longer wavelengths so that a limited degree of yellowness is imparted by the spectral filter (for example being characterized by a yellowness index of less than 15, or providing that white light has a CIE xy coordinate of 0.33, 0.33 plus or minus 0.05 units on the CIE xy chromaticity diagram. In some embodiments a contact lens provides a relatively greater amount of blue light filtering in a central zone of the vision, and a lesser inhibition of blue light in the peripheral zone, and the contrast differential between the central and peripheral zone is at least 60 percent.

U.S. Pat. No. 7,841,714B2 by Gruber filed 2008 Feb. 7 discloses an eyewear device for increasing the stimulation of the intrinsically photosensitive retinal ganglion cells and suppressing natural melatonin generation in humans, wherein the lenses of the eyewear device comprise a luminescent compound including nanocrystal applied to only a portion of the lens wherein the luminescent material emits photons with a narrow-band emission having a peak wavelength of emission between 410 to 485 nanometers. In some embodiments the luminescent material is applied only to the upper portion of the lens. In some embodiments the luminescent material is applied only to the upper temporal portion of the lens.

U.S. Pat. No. 9,759,848B2 by Blair et. al. filed 2011 Jan. 17 discloses methods of regulating or modulating circadian cycles by attenuating or enhancing the stimulation of intrinsically photosensitive retinal ganglion cells by means of a filtering lens having a notch filter substantially located at 480 nanometers (attenuating incident radiation and supporting natural melatonin generation) or located at 620 nanometers (effectively increasing incident radiation and thereby suppressing natural melatonin generation).

U.S. Pat. No. 10,384,070B2 by Pugh et. al. filed 2011 Feb. 4 discloses an apparatus for suppression of melatonin synthesis by means of an eyewear device comprising a plurality of light emitting elements that deliver light scattered over the lens, wherein the light is white, or blue substantially concentrated around 480 nanometers, or green substantially concentrated around 500 nanometers.

U.S. Pat. No. 9,778,490B2 by Pritts filed 2011 Nov. 4 discloses an optical lens filter providing a partial attenuation of wavelengths of light between 535 nanometers to 600 nanometers, and a peak in transmission occurring at about 480 nanometers. The inventors describe the lens as having benefits for mood enhancement.

U.S. Pat. No. 7,976,157B2 by Croft filed 2007 May 8 discloses eyewear for reducing eyestrain caused by viewing computer screens and/or from overhead lighting while viewing computer screens. The eyewear comprises a spectrally selective filter that attenuates peak emissions from fluorescent lamps at wavelengths of 360 nanometers, 400 nanometers, 440 nanometers, 550 nanometers and 575 nanometers. In some embodiments the eyewear lenses are configured with a gradient density and provide a relatively greater amount of filtering in the upper region of the lens.

US20140300857A1 by Cohen-Tannoudji et. al. filed 2011 Dec. 8 describes an optical substrate with spectrally selective filtering of light wherein a narrow band notch filter is provided that strongly attenuates light between about 420 nanometers to about 465 nanometers.

US20150192800A1 by Dirk et al. filed 2012 Jul. 12 (Abandoned) discloses methods of optimizing light for attenuation of light incident to the photosensitive retinal ganglion cells using filters and illuminants having a modified spectral output; embodiments of the filters include notch filters substantially centered at 490 nanometers and blocking wavelengths of light between 450 nanometers to 500 nanometers and substantially transmitting non-blocked wavelengths of light.

U.S. Pat. No. 10,007,039B2 by Aube filed 2012 Sep. 26 provides a multilayer optical interference filter with a transmittance curve that approximates the inverse of the melatonin suppression action spectrum.

U.S. Pat. No. 9,798,163B2 by Ishak et. al. filed 2013 May 5 discloses various embodiments of overall low-transmittance lenses (e.g. sunglasses) comprising a narrow-band notch absorptance having a wavelength of peak absorptance of about 435 nanometers.

U.S. Pat. No. 9,857,503B2 by Kojima et al. filed 2013 Sep. 19 discloses a polymeric optical lens material comprising a narrow-band absorptive dye that has high transmittance between 400 nanometers to 440 nanometers, a minimum transmittance between 471 nanometers to 500 nanometers, and substantially transmits wavelengths of light greater than 540 nanometers. Embodiments of the the narrow-band absorbing dye include Pd-porphyrin compound and variants thereof.

U.S. Pat. No. 10,234,608B2 by Blair et. al filed 2013 Nov. 15 describes a method of manufacturing an optical notch filter comprising a composition of nanoparticles within a host medium such that the filter provides a notch absorptance having a central wavelength of 480 nanometers, 590 nanometers or 620 nanometers and a full-width half-maximum notch width of between 50 nanometers to 100 nanometers.

U.S. Pat. No. 9,885,885B2 by Blair et. al. filed 2013 Nov. 27 describes an optical lens comprising a polymeric interference filter on a curved substrate wherein the transmittance is less than 2% across a band of blue light from 400 nanometers to between 420 to 440 nanometers and substantially transmits wavelengths of blue light greater than 450 nanometers.

U.S. Pat. No. 9,739,916B2 by Weber et. al. filed 2014 Mar. 20 discloses a polymeric-based multi-layer reflective filter capable of substantially reflecting wavelengths of light from 440 nanometers to 480 nanometers, which may be used to reduce the suppression of melatonin generation by spectral blue-content of light.

WO2015155748A1 by Legerton filed 2014 Apr. 11 discloses an ophthalmic eyewear comprising a lens that transmits less than 50% of blue light between 400 nanometers to 450 nanometers and transmits greater than 50% of blue light in the band from 460 nanometers to 500 nanometers.

U.S. Pat. No. 9,683,102B2 by Cefalo et. al filed 2014 May 5 discloses an optical filter comprising a Cu-porphyrin dye compound wherein the dye provides a narrow-band notch absorption with a peak absorptance located at approximately 420 nanometers.

US20150153489A1 by Gallas et. al. filed 2013 Sep. 11 (abandoned) discloses an optical filter for minimizing the suppression of melatonin while simultaneously maintaining good color perception (as measured using the FM-100 color vision test), wherein the filter comprises an optical film with a sloped cut-on filter that gradually transitions from 100% blocking at 450 nanometers to 100% transmitting at 700 nanometers.

U.S. Pat. No. 9,958,706B2 by Baillet filed 2015 Apr. 23 discloses a lens for enhancing the stimulation of the intrinsically photosensitive retinal ganglion cells comprising a luminescent compound that selectively emits light in the range of 460 nanometers to 530 nanometers in combination with a reflective filter that substantially reflects the emitted wavelengths in the direction of the wearer's eye.

U.S. Pat. No. 9,977,263B2 by Iordanis filed 2016 Feb. 26 discloses an ophthalmic lens comprising a front surface reflective coating that attenuates transmission of blue light in combination with a rear surface absorptive coating. The overall effect is to strongly attenuate wavelengths of light less than 420 nanometers with a gradual increase in transmission to 100% between 420 nanometers to 580 nanometers. In some embodiments a relatively greater amount of blue light filtering is provided in the central area of the lens (at or near the optical axis of the lens and eye system).

U.S. Pat. No. 10,175,508B2 by Ambler filed 2016 Mar. 14 discloses an eyewear lens product that combines a selective attenuation of blue light between 400 nanometers and 500 nanometers in combination with a photochromic material capable of reducing the overall transmittance from about 85% to about 15% when exposed to sunlight.

WO2019238648A1 by Marck et. al. filed 2018 Jun. 12 discloses optical articles having a mixture of three narrow-band light attenuating dyes substantially absorbing light between 460 nanometers and 510 nanometers, between 570 nanometers and 600 nanometers, and between 670 nanometers and 715 nanometers.

WO2020064963A1 by Barrau et. al. filed 2018 Sep. 27 describes an ophthalmic lens for improving vision that reduces the transmittance of LED-based white light sources by a factor of 32% to 90% by selectively attenuating light in the range of 400 nanometers to 460 nanometers.

US20200233236A1 by Asprey et. al. filed 2019 Jan. 18 discloses an optical lens having three discrete filtering zones organized in horizontal bands; the upper band blocking substantially all blue and green light; the middle zone blocking substantially all blue light and a lesser degree of green light, and the lower zone blocking substantially all blue light and a still lesser degree of green light.

WO2020237352A1 by Waller et. al. filed 2019 May 24 provides an eyewear system with at least two interchangeable sets of lenses, the first set providing an optical filter that substantially attenuates light between the wavelengths of 380 nanometers to 500 nanometers, and the second set providing an optical filter that substantially attenuates light between the wavelengths of 500 nanometers and 700 nanometers or a subset thereof. The lens attenuates the region of light responsible for stimulation of the retinal melatonin circuit while also achieving a neutral color appearance by the addition of the color-complementary absorption bands.

RU199083U1 filed 2020 Feb. 6 discloses an eyewear device for selectively blocking light at and around the visual axis of each eye by means of repositionable light-blocking disks placed onto each lens. The invention may be used to attenuate blue light from reaching the macular region of the eye.

US20220187628A1 by Valentine filed 2020 Feb. 25 discloses an ophthalmic lens comprising at least one dye absorbing light between 415 nanometers to 455 nanometers and at least one inhibition band centered between 510 nanometers to 610 nanometers wherein the inhibition band may improve color perception and/or the apparent lens coloration.

In spite of these inventive disclosures in the prior art, widespread adoption of eyewear for optimizing circadian health in humans has not yet been achieved, and the current market of such devices is fragmented with many different lens offerings without an apparent dominant solution. Worse, brands of eyewear currently found in the market that are advertised for use as nighttime eyewear devices provide either an insufficient amount of circadian blue light attenuation to be effective, or provide excessive attenuation of blue light and green light that is not necessary to achieve the desired effect. In addition, these brands of eyewear currently on the market offer models of blue light attenuating eyewear for daytime use that block an excessive amount of circadian blue light that is actually contraindicated for maintaining a healthy circadian entrainment to daylight. In spite of these deficiencies, the market for blue light regulating eyewear remains strong and growing, demonstrating that the concern for potentially unhealthy exposure to HEV light and blue light is an increasing problem worldwide and health consequences correlated with circadian rhythm disruption continue to increase. Therefore, the need for improved eyewear for optimizing circadian health throughout daytime and nighttime conditions is still an open question and specifically, there is currently an unmet need for ophthalmic lenses capable of performing the necessary filtering function with a high degree of effectiveness while simultaneously maintaining good quality of vision and human-centric ergonomics in a manner that is sufficient to achieve widespread consumer adoption. Consequently, a solution is provided herein.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a method of improving circadian health and protecting the eyes from high-energy visible blue light comprises selecting and then positioning an eyewear device in front of the eyes of a person so that the lenses of the device substantially filter the light received by the eyes of the person while they are performing an activity dependent upon the sense of vision, wherein if the activity is performed substantially during normal daytime hours (e.g., between 6 AM to 6 PM plus or minus 2 hours) then the eyewear device is selected from a collection of one or more daytime eyewear devices having lenses which are configured such that the mean spectral transmittance of the lenses between 430 nanometers and 490 nanometers is between 100 percent to 150 percent relative to the luminous transmittance of the lens, and the mean spectral transmittance of the lenses between 400 nanometers to 430 nanometers is less than 40 percent relative to the luminous transmittance of the lens, and if the activity is performed during substantially normal nighttime hours (e.g., between 6 PM to 6 AM plus or minus 2 hours) then the eyewear device is selected from a collection of one or more nighttime eyewear devices having lenses which are configured such that the mean spectral transmittance between 430 nanometers and 490 nanometers is less than 40 percent relative to the luminous transmittance of the lenses. In some such variations the lenses of the daytime and/or nighttime eyewear devices are configured such that the mean spectral transmittance between 400 nanometers to 430 nanometers is less than 25 percent, or is less than 5 percent, or is less than 1 percent. In some such variations, the lenses of the daytime eyewear devices are configured such that the mean spectral transmittance between 430 nanometers to 490 nanometers is greater than 105 percent, or greater than 115 percent, or greater than 125 percent, and is less than 150 percent relative to the luminous transmittance of the lenses.

In some variations of the method, the lenses of the selected daytime eyewear device are configured such that the spectral transmittance of the lenses comprises a selective yellow-absorbing notch with a peak absorptance wavelength between 575 nanometers to 600 nanometers and a full-width half-maximum notch-width between 10 nanometers to 25 nanometers and a minimum spectral transmittance less than 80 percent of the luminous transmittance of the lenses and the luminous transmittance of the lenses is greater than 80 percent.

In some variations of the method, the lenses of the selected daytime eyewear device are configured such that the mean spectral transmittance between 430 nanometers and 490 nanometers is greater than 120 percent relative to the luminous transmittance of the lenses and the mean spectral transmittance between 400 nanometers to 430 nanometers is less than 5 percent and the luminous transmittance of the lenses is less than 40 percent.

In some variations of the method, the lenses of the selected daytime eyewear device are configured such that that the mean spectral transmittance between 400 nanometers to 430 nanometers is less than 5 percent and the spectral transmittance comprises a dual-notch structure such that first narrow-band notch has a center wavelength between 480 nanometers to 500 nanometers and a full-width half-maximum notch width of between 10 nanometers to 40 nanometers, and a second narrow-band notch has a center wavelength between 565 nanometers to 600 nanometers and a full-width half-maximum notch width of between 10 nanometers to 40 nanometers.

In some variations of the method, if the activity is performed during daytime hours in the outdoors under natural daylight then the lenses of the selected eyewear device are configured to have a luminous transmittance that is between 10 percent to 35 percent, and if the activity is performed during daytime hours indoors then the lenses of the selected eyewear device are configured to have a luminous transmittance that is greater than 75 percent. In some such variations the mean spectral transmittance of the lenses between 400 nanometers to 430 nanometers are less than 5 percent, or is less than 1 percent.

In some variations of the method, if the activity is to be performed during daytime hours in both outdoors under natural daylight and indoors, then the lenses of the selected eyewear device are configured to comprise a photochromic dye such that the luminous transmittance in the darkened state is less than 40 percent, and the luminous transmittance in the faded state is greater than 75 percent, and the mean spectral transmittance between 430 nanometers to 490 nanometers is greater than 100 percent relative to the luminous transmittance in both the faded state and the darkened state.

In some variations of the methods, if the activity is to be performed during nighttime hours under ambient lighting conditions between 100 lux to 1000 lux then the lenses of the selected eyewear device are configured such that the mean spectral transmittance between 430 nanometers to 490 nanometers is between 25 percent to 40 percent relative to the luminous transmittance of the lenses, and if the activity is to be performed during nighttime hours under ambient lighting conditions between 1000 lux to 10000 lux or greater then the lenses of the selected eyewear device are configured such that the mean spectral transmittance between 430 nanometers to 490 nanometers is between less than 15 percent relative to the luminous transmittance of the lenses. In some such variations the mean spectral transmittance between 400 nanometers to 430 nanometers of the lenses is less than 5 percent, or is less than 1 percent.

In some variations of the methods, the lenses of the selected eyewear device for use during nighttime hours are configured with a gradient profile wherein the mean spectral transmittance between 430 nanometers to 490 nanometers is between 25 percent to 40 percent relative to the luminous transmittance of the lens at a location in the lower portion of the lenses, and the mean spectral transmittance between 430 nanometers to 490 nanometers is less than 15 percent relative to the luminous transmittance of the lens at a location in the upper portion of the lenses. In some such variations the mean spectral transmittance between 400 nanometers to 430 nanometers of the lenses is less than 5 percent, or is less than 1 percent.

In another aspect of the invention, a method of improving circadian health comprises selecting and then positioning an eyewear device in front of the eyes of a person so that the lenses of the device substantially filter the light received by the eyes of the person while they are performing an activity dependent upon the sense of vision, wherein the activity is performed substantially during substantially normal nighttime hours (e.g., between 6 PM to 6 AM plus or minus 2 hours) and the eyewear device is selected from a collection of two or more nighttime eyewear devices wherein if the activity is to be performed during nighttime hours under ambient lighting conditions between 100 lux to 1000 lux then the lenses of the selected eyewear device are configured such that the mean spectral transmittance between 430 nanometers to 490 nanometers is between 25 percent to 40 percent relative to the luminous transmittance of the lenses, and if the activity is to be performed during nighttime hours under ambient lighting conditions between 1000 lux to 10000 lux or greater then the lenses of the selected eyewear device are configured such that the mean spectral transmittance between 430 nanometers to 490 nanometers is less than 15 percent relative to the luminous transmittance of the lenses. In some such variations the mean spectral transmittance between 400 nanometers to 430 nanometers of the lenses is less than 5 percent, or is less than 1 percent.

In another aspect of the invention, a method of improving circadian health comprises positioning an eyewear device in front of the eyes of a person so that the lenses of the device substantially filter the light received by the eyes of the person while they are performing an activity dependent upon the sense of vision, wherein the activity is performed substantially during substantially normal nighttime hours (e.g., between 6 PM to 6 AM plus or minus 2 hours) and the lenses of the eyewear device are configured with a gradient profile wherein the mean spectral transmittance between 430 nanometers to 490 nanometers is between 25 percent to 40 percent relative to the luminous transmittance of the lens at a location in the lower portion of the lenses, and the mean 5 spectral transmittance between 430 nanometers to 490 nanometers is less than 15 percent relative to the luminous transmittance of the lens at a location in the upper portion of the lenses. In some such variations the mean spectral transmittance between 400 nanometers to 430 nanometers of the lenses is less than 5 percent, or is less than 1 percent.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a front view of a spectacle eyewear device in accordance with an embodiment of the present invention.

FIG. 2 is a graph of the spectral sensitivity of various photo-sensitive mechanisms in the human visual system.

FIG. 3 is a graph of the spectral transmittance of a lens for an eyewear device used during daytime hours in accordance with an embodiment of the present invention.

FIG. 4 is a graph of the spectral transmittance of a lens measured at various points along the vertical optical axis for an eyewear device used during daytime hours in accordance with an embodiment of the present invention.

FIG. 5 is a graph of the spectral transmittance of a lens comprising a narrow-band selective dye for an eyewear device used during daytime hours in accordance with an embodiment of the present invention.

FIG. 6 is a graph of the spectral transmittance of a lens comprising a photochromic dye measured in a darkened state and in a faded state for an eyewear device used during daytime hours in accordance with an embodiment of the present invention.

FIG. 7 is a graph of the spectral transmittance of a Category 3 sunglass lens for an eyewear device used during daytime hours in accordance with an embodiment of the present invention.

FIG. 8 is a graph of the spectral transmittance of a Category 2 sunglass lens comprising a dual-notch structure for an eyewear device used during daytime hours in accordance with an embodiment of the present invention.

FIG. 9 is a graph of the spectral transmittance of a lens for an eyewear device used during nighttime hours in accordance with an embodiment of the present invention.

FIG. 10 is a graph of the spectral transmittance of a lens for an eyewear device used during nighttime hours in accordance with an embodiment of the present invention.

FIG. 11 is a graph of the spectral transmittance of lens measured at various points along the vertical optical axis for an eyewear device used during nighttime hours in accordance with an embodiment of the present invention.

FIG. 12 is a process flow diagram for a method of using two or more eyewear devices to improve human circadian health and protect the eyes from high-energy visible blue light while performing activities during daytime and nighttime hours.

FIG. 13 is a process flow diagram for a method of using three or more eyewear devices to improve human circadian health and protect the eyes from high-energy visible blue light while performing activities during daytime and nighttime hours, wherein a suitable eyewear device for daytime use may be selected depending upon if the activity is performed indoors or performed outdoors.

FIG. 14 is a process flow diagram for a method of using three or more eyewear devices to improve human circadian health and protect the eyes from high-energy visible blue light while performing activities during daytime and nighttime hours, wherein a suitable eyewear device for nighttime use may be selected depending upon if the activity is performed under high brightness lighting conditions, or low to moderate brightness lighting conditions.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide ophthalmic devices, systems and methods to modify the spectral power distribution of light received by the retina of a person while performing various activities depending upon the sense of vision during daytime and nighttime lighting conditions.

For the purposes of this disclosure, the term “substantially” is defined to mean “essentially” or “approximately,” wherein the terms refer to a range of numbers that one of skill in the art would consider near the stated amount, for example by about 1%, 5%, or 10%, including increments, even if numeric values are not explicitly indicated. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time.

For the purposes of this disclosure, the following terminologies are used to assist in the detailed description of one or more embodiments of the present invention:

An eyewear device is an apparatus worn on the face or the eyes to provide one or more functions including eye protection, refractive correction, and spectral filtering of light. Eyewear devices include contact lenses, spectacles (also called glasses), face shields and goggles. A spectacle eyewear device is an eyewear device nominally comprising a first lens and a second lens and a frame that enables the lenses to be positioned proximally to the eyes so that a substantial portion of the person's field of view is seen through the lenses. In some variations, an eyewear device may comprise a unitary lens that covers both eyes, such as a “wrap around” design or eye shield.

When referring to a lens or lenses of an ophthalmic device, the optical center refers to a point that is approximately coincident with the location of the pupil of one eye of the person when looking straight forward. For example, in a spectacle eyewear device comprising a first lens and a second lens mounted in a spectacle frame, the optical center of the lenses is configured in such a way that their relative distance is equal to the person's inter-pupillary distance. The optical axis of a lens is an imaginary line normal to the lens surface, extending through the pupil of one eye and the optical center of the lens.

An ophthalmic lens may comprise one or more filters (e.g., films, dyes, reflective coatings, etc). The transmittance of a lens is the transmittance of all such filters in combination. For the purposes of the present disclosure, unless specified otherwise, the transmittance of a lens shall be measured approximately at the optical center of the lens in a direction substantially normal to the surface of the lens and averaged over a circular area of approximately 1 millimeters to 10 millimeters diameter. This method of measuring the transmittance of a lens is consistent with the recommended procedure for measurement of the transmittance properties of sunglasses defined in American National Standards Institute ANSI Z80.3-2018, “Ophthalmics-Nonprescription Sunglass And Fashion Eyewear Requirements”.

In the case of a lens having a gradiently-distributed light attenuating material (also referred to as having a gradient profile), a measurement in the upper portion of the lens shall be performed approximately 5 millimeters above the optical center, and a measurement in the lower portion of the lens shall be performed approximately 10 millimeters below the optical center, and a measurement in the middle portion of the lens shall be performed substantially at the optical center of the lens.

The transmittance of an optical filter is the fraction of light (or percentage) of light that passes through the filter, which may be stated in percent from zero to 100 percent. The spectral transmittance is the transmittance as a function of wavelength. For the purposes of the present disclosure, the wavelengths of relevance are the wavelengths of visible light between approximately 400 nanometers to approximately 700 nanometers.

The luminous transmittance of a lens is the weighted integral of spectral transmittance using the phototopic sensitivity function, which is a weighting function that approximates the human eye's sensitivity to the intensity of light as a function of wavelength. For the purposes of the present disclosure, the luminous transmittance of a lens may be calculated according to ANSI Z80.3-2018 Section 5.7.1.

The lenses of eyewear devices may be usefully categorized by overall luminous transmittance using a system of Category levels, wherein Category 0 (zero) lenses have a luminous transmittance between 75 percent to 100 percent, Category 1 (one) lenses have a luminous transmittance between 40 percent to 75 percent, Category 2 lenses have a luminous transmittance between 18 percent to 40 percent, Category 3 lenses have a luminous transmittance between 8 percent to 18 percent, and Category 4 lenses have a luminous transmittance that is less than 8 percent.

The white-point of a lens refers to the color of a white light after it has been transmitted through the lens or filter. The color may be expressed in chromaticity coordinates, such as the CIE 1931 xy color space. A white-point is defined relative to an illuminant, such as CIE Standard Illuminant D65. For the purpose of analyzing the white-point of sunglass lenses the D65 illuminant is preferable as it approximates the spectral power distribution of average daylight. The chromaticity coordinates of D65 as viewed through a lens may be calculated according to ANSI Z80.3-2018 Section 3.8.2.1.

The color appearance (or “tint”) of a lens generally refers to the color appearance of a lens positioned substantially proximal to a surface (such as a table, or the face of a person), and is also referred to as the “two-pass” color which is the result of white light passing through the lens, reflecting from a white surface, and then passing through the lens again. A pair of lenses may have different spectral transmittances while providing substantially identical color appearances.

Some eyewear devices may have lenses that comprise photochromic dyes, which are dyes that darken when exposed to ultraviolet light such as from sunlight, and therefore may have varying spectral transmittance properties according the lighting conditions within which an eyewear device is used. The present disclosure anticipates that eyewear in one or more embodiments may include a photochromic dye component, however it is not a necessary limitation of all embodiments. For lenses that may include a photochromic dye component, the measurement method of ANSI Z80.3-2018 Section 5.8.3 defines the methods for conditioning and measuring a lens in the faded state and in the darkened state (after exposure to simulated solar radiation for 15 minutes), and in other conditions such as moderate light exposure and under twilight lighting conditions.

In the field of ophthalmic devices comprising lenses, the horizontal axis refers to an imaginary reference line upon a lens of the device that is oriented parallel to the apparent horizon line as seen by a person wearing said eyewear device. The vertical axis refers to an imaginary reference line perpendicular to the horizontal axis. The horizontal axis, vertical axis, or other specified axis may be depicted as imaginary reference lines passing through the geometric center of a lens (i.e., the geometric midpoint of a lens), or through the optical center of a lens (i.e., a point coincident with the center of the pupil of a person wearing the lens when mounted in a spectacle eyewear frame and positioned upon the face in the normal manner).

The present disclosure may refer to spectral properties of lenses using mathematical functions that are computed over a range of spectral values, such as the mean, minimum and maximum. The range of spectral values over which the function is computed shall be stated. For example, the mean spectral transmittance between 450 nanometers to 500 nanometers is the average of the spectral transmittance over each wavelength in the range 450 nanometers to 500 nanometers (for example, the sum of the spectral transmittance at each wavelength in the range sampled at an increment of 1 nanometer and then divided by 50). In another example, the minimum spectral transmittance of a lens between 550 nanometers to 600 nanometers is lowest value of the spectral transmittance within the wavelength range.

In the present disclosure, any measurement involving the calculation of a mean, minimum or maximum, or other function calculated over a range of wavelengths, a sampling method such as calculating at 1 nanometer intervals is preferable, however other step sizes may also be acceptable, provided that the step sizes are sufficiently small to represent the underlying spectral function without aliasing, for example step sizes between 0.1 nanometers up to 25 nanometers may be result in substantially equivalent calculations. For spectral functions containing narrow-bandwidth features such as notch filters, the sampling step size must be less than or equal to half the width of any such narrow-band feature.

Spectral functions (for example, the spectral transmittance, spectral polarization efficiency, etc.) are continuous probability density functions and therefore the inclusion of endpoints in any such calculation is immaterial. Similarly, two spectral ranges may be considered non-overlapping even if they share an endpoint; for example, the sub-band 450 nanometers to 500 nanometers is non-overlapping with the sub-band 500 nanometers to 550 nanometers.

In the present disclosure, spectral properties of lenses may be described in relative terms. For example, if we state that the mean spectral transmittance between 400 nanometers to 500 nanometers is less than 25 percent relative to the luminous transmittance of a lens, the relative relationship may be calculated using the following method: first, the luminous transmittance of the lens is measured (for example using the method of ANSI Z80.3 Section 5.7.1) resulting in a first value, A. Next, the mean spectral transmittance may be calculated over the specified range, resulting in a second value, B. Next, we can determine if a lens satisfies the relative properties stated above by testing if B is less than 0.25 times A. For the purposes of the present disclosure, if a relative spectral property is described without specific reference to measurement in a darkened state or a faded state, it shall be assumed that the property must be true over both the darkened state and faded states of a lens, to the extent the lens contains any photochromic dyes that undergo state transitions dependent upon temperature and/or lighting conditions.

Spectral ranges of particular relevance to the present disclosure include: 1) between 400 nanometers to 430 nanometers, which substantially corresponds to high-energy visible blue light; 2) between 430 nanometers to 490 nanometers, which substantially corresponds to circadian blue light, which are the components of blue light to which the human circadian system is primarily responsive over long time periods; 3) between 430 nanometers to 550 nanometers, which substantially corresponds to the in-vitro spectral sensitivity of the melanopsin photopigment; 4) between 550 nanometers to 600 nanometers, which substantially corresponds to yellow light (including greenish-yellow and yellow-orange colors of light); 5) between 575 nanometers to 600 nanometers, which substantially corresponds to a narrow sub-band of pure or nearly pure yellow light; 6) between 600 nanometers to 650 nanometers, which substantially corresponds to red light.

In the present disclosure, the intensity of lighting refers to the average surface illumination, measured in units of lux (lumens per square meter), by substantially white lighting. Substantially white light includes light emitters with a color rendering index (CRI) greater than 70 and a correlated color temperature (CCT) between approximately 2700 Kelvin to 6500 Kelvin. Common sources of such light include ceiling-mounted lights, desktop and tabletop lamps, in addition to light-emitting display screens such as televisions, mobile devices and computer screens. Such lights are used to illuminate indoor spaces within which people live or work while performing various activities during daytime or nighttime hours.

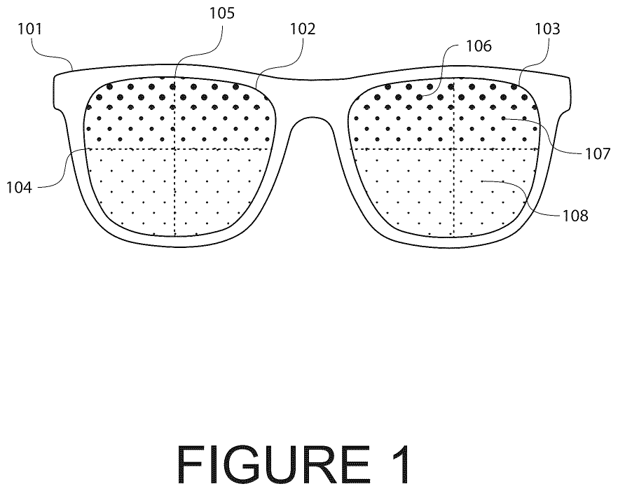

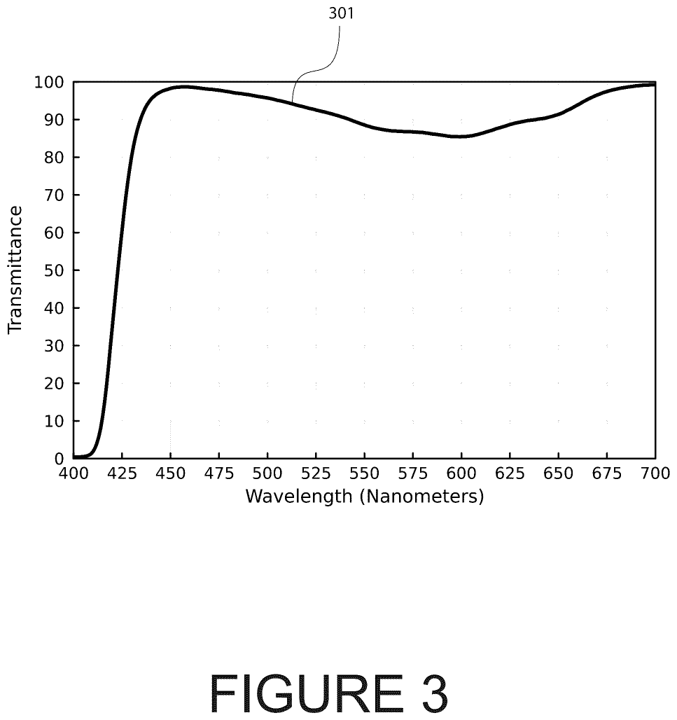

An embodiment of a spectacle eyewear device in accordance with the present invention is depicted in FIG. 1, wherein a spectacle eyewear device comprises a frame 101, a first lens 102, and a second lens 103. The lenses are annotated with dotted and dashed lines to show the orientation of the horizontal axis 104 and vertical axis 105. The horizontal axis is substantially parallel to the horizontal meridian of the field of view as seen by a person wearing the frame. In the embodiment shown, the eyewear device is fitted with lenses having a gradient disposition of light attenuating material with an increased density (i.e., lower transmittance) in the upper region of the lenses, and a lower density of light attenuating material (i.e., higher transmittance) in the lower region. The varying transmittance in the regions are indicated by the size of the dot pattern whereas the larger dots shown at 106 represent where the light attenuating material has its highest optical density (i.e., lowest transmittance), the region with medium-sized dots at 107 represents a region with moderate optical density (i.e., a midpoint of transmittance between the upper and lower regions), and the small dots shown at 108 represent a lower region of the lens within which the light attenuating material has the lowest density (e.g., highest transmittance). In some variations of the present invention, spectacle eyewear devices need not have a gradient disposition of light-attenuating material as shown, but may instead have a substantially uniform disposition of light-attenuating material. In the foregoing description, “higher transmittance” may refer to overall luminous transmittance of the lenses relative to a region of “lower transmittance”, or may refer to the relative spectral transmittance at one or more wavelengths of visible light. The spectral transmittance of such lenses at various locations (if gradiently disposed) and/or uniformly disposed are described hereafter along with FIG. 3 through FIG. 11.

The present invention is related to eyewear devices having lenses with wavelength-selective transmittance properties, and more specifically is related to eyewear devices having lenses with wavelength-selective spectral transmittance properties characterized by a mean spectral transmittance within one or more sub-bands of visible light. A sub-band of light is a contiguous region of light wavelengths within the visible light spectrum, which may be described by defining the endpoints of the sub-band, for example 400 nanometers to 430 nanometers corresponds to a sub-band of light commonly called high-energy visible blue light (HEV light).

Sub-bands of visible light relevant to the present disclosure include certain bands that are relevant to one or more physiological functions of the human body, such as those associated with certain radiation hazards, or those responsible for stimulating the human circadian rhythms, and certain sub-bands that are relevant to colorimetric properties of wavelength-selective filters, for example sub-bands that influence the overall luminous transmittance of a lens or the apparent color or “tint” of a lens.

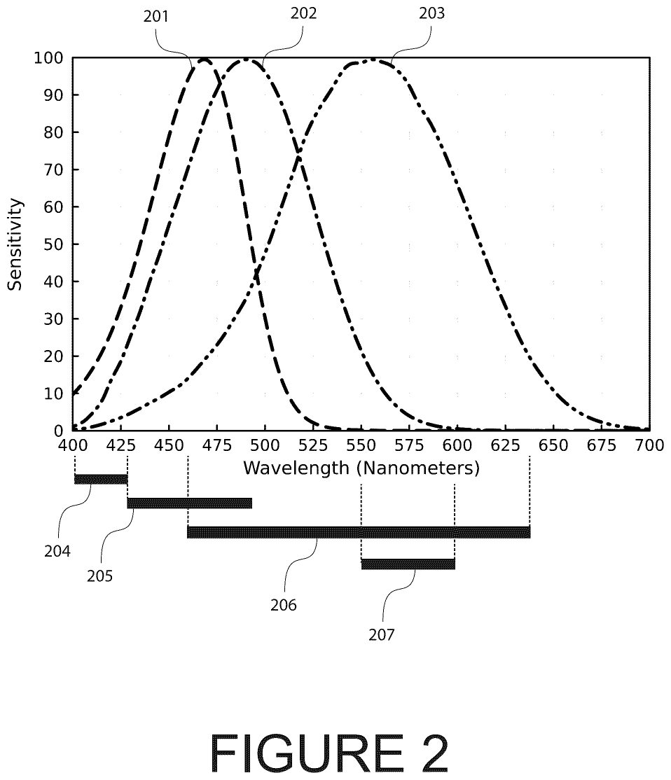

FIG. 2 depicts a graph of the spectral sensitivity of a collection of functions of particular interest, and the wavelength boundaries of certain sub-bands of light that are of specific relevance to the present invention.

In FIG. 2, the dot-dot-dashed curve at 203 corresponds to the human photopic sensitivity curve, which is used to calculate the luminous transmittance of a lens under photopic viewing conditions. The human eye is most sensitive to the wavelengths of light between approximately 460 nanometers to 630 nanometers, which are indicated as a sub-band by the rectangular block at 206.

Continuing with FIG. 2, the dot-dashed curve at 202 represents the melanopic sensitivity curve, obtained from in-vitro measurement of the melanopsin photopigment. The melanopsin photopigment is the primary light-absorbing molecule contained in the intrinsically photosensitive retinal ganglion cells (ipRGCs), a type of light sensitive cell found in the human retina which does not contribute to vision, but rather sends a photopically-stimulated signal to the super-chiasmatic nucleus (SCN) which strongly influences the entrainment of the human body's circadian systems to the 24-hour cycle of light and dark caused by sunlight. By observing the shape of this sensitivity curve it may be seen that the melanopic sensitivity curve extends broadly over the sub-band of light between 430 nanometers to 550 nanometers. Furthermore, whereas the photopic sensitivity has a maximum sensitivity at 555 nanometers, the melanopic sensitivity curve and the photopic sensitivity curve have a substantial amount of overlap.

Continuing with FIG. 2, the dashed curve at 201 corresponds to the circadian potency function, which represents the in-vivo sensitivity of the human circadian system to wavelengths of blue light substantially limited to the sub-band of light between 430 nanometer to 490 nanometers as indicated by the rectangular block at 205. An important distinction between the melanopic sensitivity function (202) and the circadian potency function (201) are the methods of measurement: the melanopic sensitivity function is derived by performing spectroscopic analysis of the isolated melanopsin photopigment, however recent studies of human circadian health have shown that this function is not an accurate approximation of the relative contribution of wavelengths of light to the entrainment of the human circadian system in a living organism under common environmental conditions. For example, current data shows that green light (e.g., light between 500 nanometers to 550 nanometers) has only a short-term effect on the human circadian system that vanishes in long-term studies of circadian entrainment (e.g., over the duration of many hours or multiple sequential days). Furthermore, current data suggests that long wavelength light such as yellow, orange and red light (e.g., light between 550 nanometers to 650 nanometers) may have an inhibitory effect on the absorption spectrum of the melanopsin photopigment, in addition to inhibitory effects due to contributions of the color-sensing cone cells, resulting in a reduced sensitivity in the human circadian system to medium and long wavelengths of light under polychromatic lighting. The circadian potency function 201 is derived from long-term studies of human volunteers under various polychromatic lights and is believed by the author of the present disclosure to be a preferable metric against which to measure the performance of eyewear lenses that attenuate and/or transmit the specific sub-band of light corresponding to psysiologically-relevant circadian blue light, which is the sub-band of light between 430 nanometers to 490 nanometers. The specific derivation of the circadian potency function and its definition may be found in the journal article, “Circadian Potency Spectrum in Light-Adapted Human” by Moore-Ede, M. and Heitmann, A. (2022). in Journal of Cell Science & Therapy, 13(5), 361. A specific advantage of this more nuanced understanding of wavelength-dependent circadian entrainment in humans is that the circadian potency function has less overlap with the photopic sensitivity function than does the melanopic sensitivity function, and therefore methods of improving circadian health by regulating blue light exposure at one or more times of day are more useful and more likely to be accepted by users due to providing lenses with a greater amount of luminous transmittance and reduced color distortion while also providing good efficacy with respect to protecting the eyes and enhancing the quality (e.g. regularity and durations) of circadian rhythms.

Continuing with FIG. 2, two additional sub-bands of interest are depicted in rectangular blocks: the sub-band between 400 nanometers to 430 nanometers at 204, which corresponds to high-energy visible blue light (HEV light) and the sub-band of light between 550 nanometers to 600 nanometers which corresponds to substantially yellow light (including greenish-yellow and yellow-orange light). HEV light has a violet or blue color appearance, and is a sub-band of light with possible health concerns due to the greater amount of energy per photon (compared to longer wavelengths of light), and the ability of photons having these wavelengths to pass through the cornea and lens of the eye and penetrate into the sensitive tissues of the human retina. Due to the increasing lifespans of people worldwide, and the debilitating effect of vision problems later in life, lifetime accumulated exposure to HEV light is a significant concern. The primary source of HEV light exposure is from sunlight, which contains a high intensity of HEV light. HEV light has only a small overlap with the circadian potency function, therefore blocking of HEV light can be performed with minimal effect on circadian entrainment, however a high amount of blocking (e.g. blocking of more than 50 percent or more than 75 percent or more than 90 percent or more than 99 percent) of HEV light causes an apparent yellowing of an eyewear lens, which can have a negative consequence to circadian entrainment due to under-stimulation of the light-responsive circadian stimulation during daytime hours, and may also be objectionable to the user's vision experience. This yellowing effect can be counteracted by reducing the transmittance of a lens over the yellow sub-band of light previously mentioned, e.g. by reducing the transmittance of the lens between 550 nanometers to 600 nanometers, however other sub-bands of attenuation are also possible such as between 550 nanometers to 650 nanometers or between 600 nanometers to 650 nanometers. Preferably, the color tint of the lens is generally blue rather than green, therefore there is a preference to configured such lenses with a selective attenuation of yellow light rather than attenuation of red light. A selective attenuation of the yellow sub-band of light generally also has a beneficial effect on the quality of vision by enhancing the M-cone to L-cone signal to noise ratios resulting in an apparent enhancement to red and green colors and an experience of increased clarity of vision and reduction of perceived glare.

The human circadian system evolved over millions of years to optimally synchronize human biological systems to the 24-hour cycle of daylight in tropical, generally equatorial zones of the Earth, where the duration of daytime and nighttime hours are approximately equal, with the sunrise and sunset occurring substantially between 6-8 AM and 6-8 PM, respectively. Therefore, for the purpose of the present disclosure, we define the normal daytime hours as occurring between 6 AM to 6 PM plus or minus two hours, and the normal nighttime hours from 6 PM to 6 AM, plus or minus to two hours.

In modern times, the distribution of human population has spread to areas distant from the equator which may have unusually long and unusually short durations of daylight, and the widespread availability of electricity and low-cost lamps enables humans to perform many activities during nighttime hours in addition to enhancing the security of outdoor areas by installing street lighting in urban areas. However, studies have also shown strong correlations between people performing activities at night (such as night-shift workers) and the prevalence of negative health consequences ranging from depression, fatigue, and gastro-intestinal distress to diabetes and cancer. Performing activities at night with the assistance of artificial light is believed to disrupt the human circadian system due to the strong effect of blue light on the inhibition of melatonin, for example as shown by the circadian potency function discussed previously. The increasing popularity of light emitting diode-based (LED) lighting utilizing a blue-emitting phosphor pump, combined with the market's myopic focus on efficiency-per-watt goals has further exacerbated the problem by causing the widespread installation of blue-rich LED lighting, often with high CCT into residential and commercial spaces. Indiscriminate use of these lights during nighttime hours disrupts the human circadian system, and in spite of widespread knowledge of the detrimental effects of blue light within the medical community, the lighting industry remains slow to provide healthy, human-centric lighting products. When confronted with lighting conditions that cannot be easily or economically changed to safe, human-centric options, it is useful for people to use blue-light regulating eyewear to improve their personal health.

In addition to the dangers of excess blue-light at night, modern work and lifestyle changes are increasingly causing people to spend more time indoors during daylight hours, resulting in an understimulation of their circadian system due to insufficient exposure to the high intensity blue light components found in sunlight. At the same time, doctor's recommendations to spend more time outdoors may result in unintended damage to the eyes due to exposure to UV light and HEV light components of sunlight. UV light transmittance limits in eyewear and sunglasses are established by FDA guidelines, but the FDA and ANSI governing bodies defining standards for eyewear devices have declined to provide guidance for exposure limits on HEV light and circadian blue light. Therefore, it is useful to provide improved eyewear devices that protect against HEV light and provide optimal levels of circadian blue light depending upon the anticipated use of the eyewear device for performing either daytime or nighttime activities.

With respect to a preferable eyewear device for use in daytime activities in accordance with the present invention, an improved lens design may be configured to provide the spectral transmittance curve as shown in FIG. 3 at 301. In this example, the lens has a mean spectral transmittance between 400 nanometers to 430 nanometers of approximately 25 percent, which results in a substantial attenuation of dangerous HEV light. To counterbalance the potential yellowing of the lens caused by the HEV light attenuation, a yellow-absorbing dye may be added to the lens to provide an attenuation of light between 550 nanometers to 600 nanometers. Alternatively or additionally, a yellow-reflecting coating may be added to the outside surface of the lens (commonly called a “gold revo coating”). Furthermore, whereas the lens is intended for use during daytime hours, and whereas it is beneficial to human circadian health to provide sufficient stimulation to the ipRGC cells by transmitting a high proportion of circadian blue light to the eyes, it is beneficial for the lenses of a daytime eyewear device to be configured to provide a transmittance of circadian blue light that is greater than unity, when compared on a relative basis to the luminous transmittance of the lens. Specifically, this may be calculated in the example shown by measuring the mean spectral transmittance of the lens between 430 nanometers and 490 nanometers, which is approximately 95 percent in this example, then comparing this to the luminous transmittance of the lens which is approximately 90 percent, and taking the ratio to determine that the mean spectral transmittance between 430 nanometers to 490 nanometers is 105 percent relative to the luminous transmittance of the lens. Thus, a lens with the spectral transmittance properties as shown can effectively protect the eyes from HEV light while also enhancing the entrainment of the circadian system by ensuring the stimulation of the eyes by circadian blue light is greater than 100 percent, therefore at least providing parity with an unfiltered view, or potentially enhancing the overall exposure to “good” circadian blue light during the daytime hours by increasing the retinal exposure to circadian blue light after accounting for pupillary dilation.

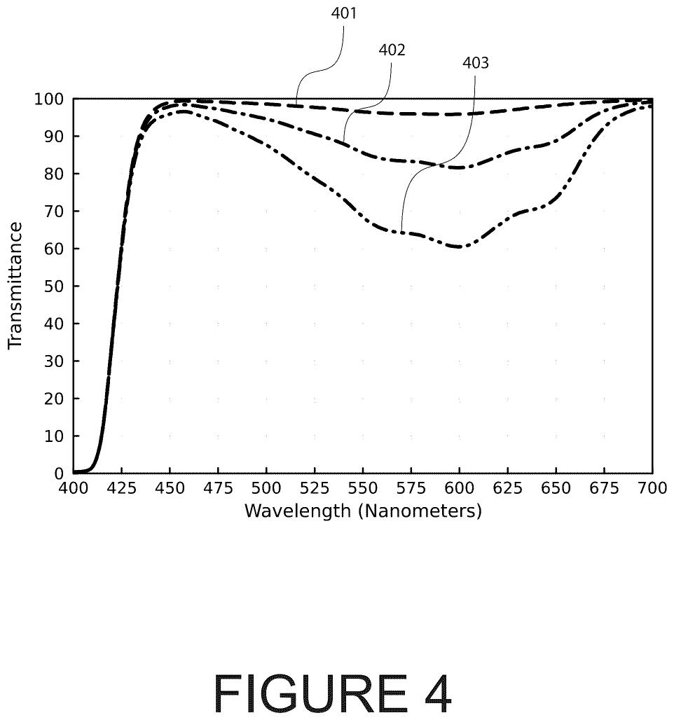

In another example of a preferable eyewear device for daytime use in accordance with the present invention, FIG. 4 depicts the spectral transmittance of a lens comprising a gradiently disposed light-attenuating material (i.e., a gradient profile), for example as depicted in FIG. 1, wherein the spectral transmittance of the lenses measured in the upper portion of the lens corresponds to the dot-dot-dashed curve at 403, and the spectral transmittance of the lenses measured in the middle of the lenses corresponds to the dot-dashed curve at 402, and the spectral transmittance of the lenses measured in the lower portion of the lenses corresponds to the dashed curve at 401. Such an embodiment may be preferable because 1) the overall luminous transmittance of such a lens could be greater compared to a uniformly-tinted lens, for example if having the spectral sensitivity of FIG. 3 at 301 over the entire lens, and 2) the ratio of circadian blue light to luminous transmittance can be significantly greater than unity in the upper portion of the lens, for example around 115 percent to 125 percent, and 3) the circadian response of the human eye is greater for light originating in the upper portion of the field of view, such as from the blue color of the daytime sky.

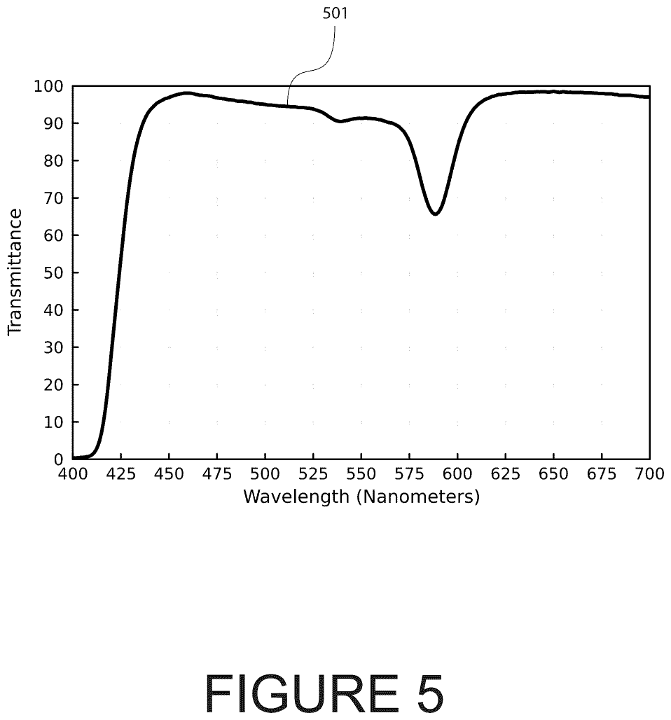

In another example of a preferable eyewear device for daytime use in accordance with the present invention, FIG. 5 depicts the spectral transmittance for a lens at 501 having substantially similar properties as the lens discussed in FIG. 3 (e.g. having a greater than unity relative transmittance of circadian blue light, and an attenuation of HEV light and yellow light), however in the example of FIG. 5 the yellow-light attenuation is provided by a narrow-band notch feature wherein a wavelength of minimum transmittance occurs at around 580 nanometers and the notch full-width half-maximum width of the notch is approximately 20 nanometers, and the lowest value of transmittance within the notch is below 80 percent of the luminous transmittance of the lens. Compared to the previous example that used a broad-band light attenuation, the narrow-band attenuation provides improved M-cone to L-cone signal-to-noise ratio and less diminishment of the luminous transmittance of the lens. Therefore, the user of an eyewear device comprising such lenses may experience a greater clarity of vision and enjoyment of the quality of vision when wearing the eyewear. In situations where the lens is required to be manufactured with a uniformly-distributed light attenuating material, the use of a narrow-band yellow absorber as shown is particularly preferable as it provides the least amount of visual disruption while still delivering the other benefits described above.

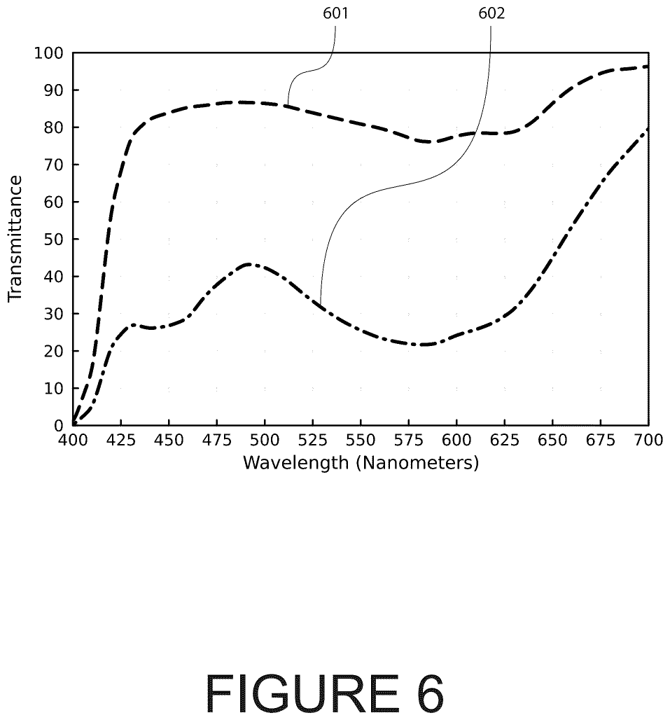

In another example of a preferable eyewear device for daytime use, FIG. 6 depicts the spectral transmittance curves of an eyewear lens comprising blue-tinted photochromic dyes, wherein the spectral transmittance of the lens in the faded state is shown at 601 and the spectral transmittance in the darkened state is shown at 602. An eyewear device comprising such lenses may be preferable for use during daytime hours when a person may be performing activities both indoors and outdoors, or outdoors under varying lighting levels (e.g. cloudy to sunny conditions), whereas the lenses provide a strong attenuation of HEV light that is “activated” by exposure to the UV components of sunlight (e.g. a mean transmittance between 400 nanometers to 430 nanometers that is less than 15 percent in the darkened state), while also providing a greater-than-unity transmittance of circadian blue-light (e.g. a mean transmittance between 430 nanometers to 490 nanometers that is around 105 percent of the luminous transmittance in the darkened state). A photochromic lens with the properties as shown may range in luminous transmittance from a Category 0 (zero) or Category 1 lens in the faded state, to a Category 2 or Category 3 in the darkened state.

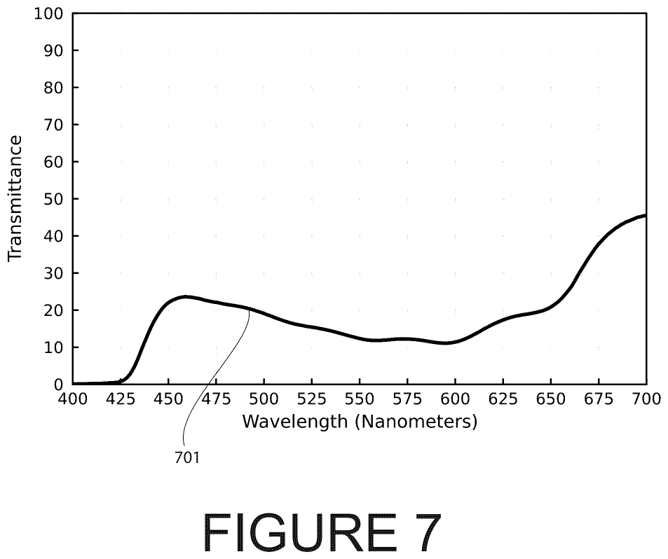

In another example, a preferable eyewear device for performing activities during daytime hours outdoors under sunlight in accordance with the invention may comprise lenses having the transmittance spectrum as shown in FIG. 7 at 701. Herein, the lenses may provide an improved attenuation of HEV light for example having a mean spectral transmittance between 400 to 430 nanometers that is less than 1 percent (i.e., a UV430-rated lens), in combination with a substantial attenuation of yellow light such that the mean spectral transmittance between 430 nanometers to 490 nanometers is preferably at least 125 percent of the luminous transmittance of the lens. Greater amounts of relative transmittance are possible, however as a practical concern the amount of color distortion and general visual discomfort increases with lenses that are excessively blue-tinted and therefore the author believes an upper bound of circadian blue light transmittance equal to 150 percent relative to the luminous transmittance is a preferable limit for practical consumer-use products. The substantially greater-than-unity transmittance of circadian blue light relative to luminous transmittance of the lens may help compensate for the chronic under-stimulation of blue light caused by spending too much time indoors, for example a person wearing the lens may achieve a faster resynchronization of their circadian rhythm to sunlight by wearing an eyewear device comprising these lenses outdoors for a shorter period of time than would be required for a neutral density (i.e., gray tinted) sunglass of equivalent luminous transmittance.

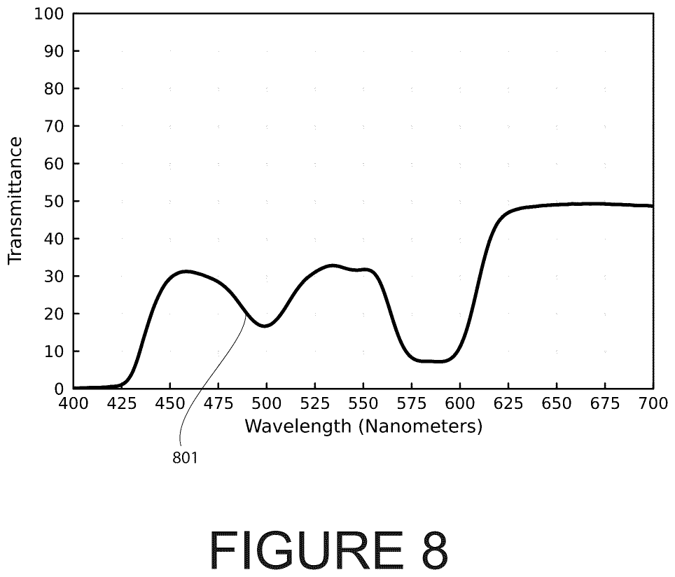

In another example, a preferable eyewear device for performing activities during daytime hours outdoors under sunlight in accordance with the invention may comprises lenses having the dual-notch transmittance spectrum as shown in FIG. 8 at 801. Dual-notch filters are preferred by some users due to their ability to enhance color vision. However, the placement of a first narrow-band transmittance notch at approximately 490 is contraindicated for needed stimulation of the circadian system because the notch would substantially overlap with the sub-band of greatest circadian potency. Accordingly, in the example transmittance spectrum as shown the first notch substantially centered at 490 nanometers has a relatively small amount of absorption, while a second yellow-absorbing notch is wider and deeper, resulting in a mean spectral transmittance between 430 nanometers to 490 nanometers that is 105 percent of the luminous transmittance of the lens, thus combining several useful features including color enhancement, eye protection from HEV light, and providing adequate stimulation by the circadian blue light components of sunlight.

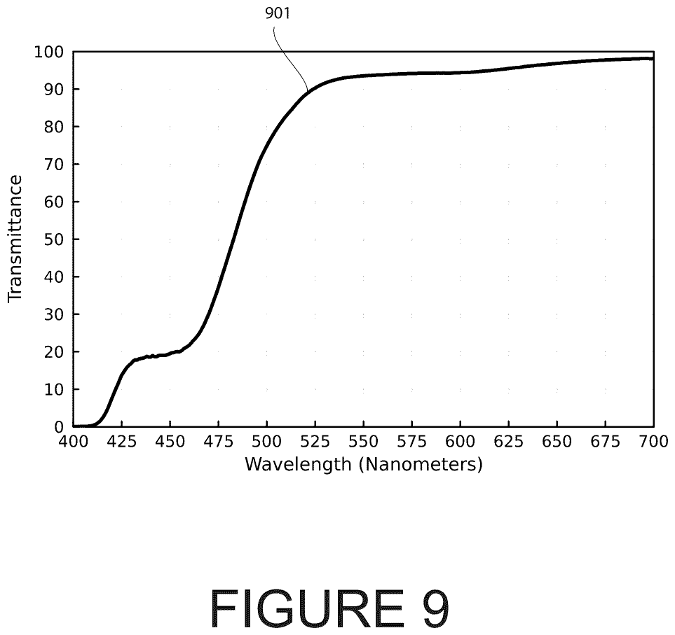

In another example of a preferable eyewear device for nighttime use in accordance with the present invention, the graph of FIG. 9 shows the spectral transmittance at 901 for a lens that substantially attenuates the amount of circadian blue light received by the eyes of a person wearing the eyewear. In this example, the mean transmittance of the lens between 430 nanometers to 490 nanometers is approximately 40 percent relative to the luminous transmittance of the lens. The luminous transmittance of the lens as shown is approximately 80 percent, making this a Category 0 (zero) lens. In typical residential environments, indoor lighting levels at night are relatively low, for example having an average surface illumination between 100 lux to 1000 lux. Under these conditions, a safe level of nighttime circadian blue light exposure (specifically, less than 2 microwatts per square centimeter of light having wavelengths between 430 nanometers to 490 nanometers) can be obtained by wearing an eyewear device comprising a Category 0 (zero) lens as shown here.

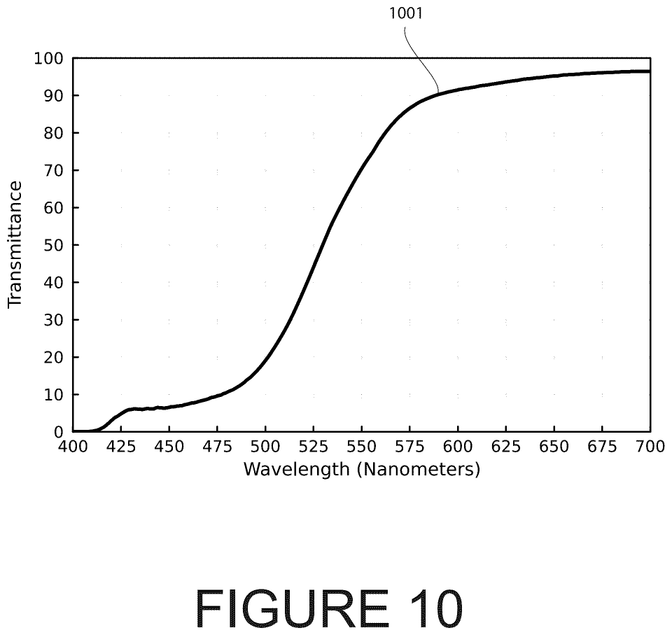

In another example of a preferable eyewear device for nighttime use in accordance with the present invention, the graph of FIG. 10 shows the spectral transmittance at 1001 for a lens that substantially and significantly attenuates the amount of circadian blue light received by the eyes of a person wearing the eyewear. In this example, the mean transmittance of the lens between 430 nanometers to 490 nanometers is approximately 15 percent relative to the luminous transmittance of the lens. The luminous transmittance is approximately 60 percent, making this a Category 1 lens. The use of an eyewear device comprising such lenses is preferable for performing nighttime activities under high intensity lighting conditions, such as what may be commonly found in commercial and retail buildings, or under high-intensity work lights used in nighttime construction, which may provide an average surface illumination between 1000 lux to 10000 lux or greater.

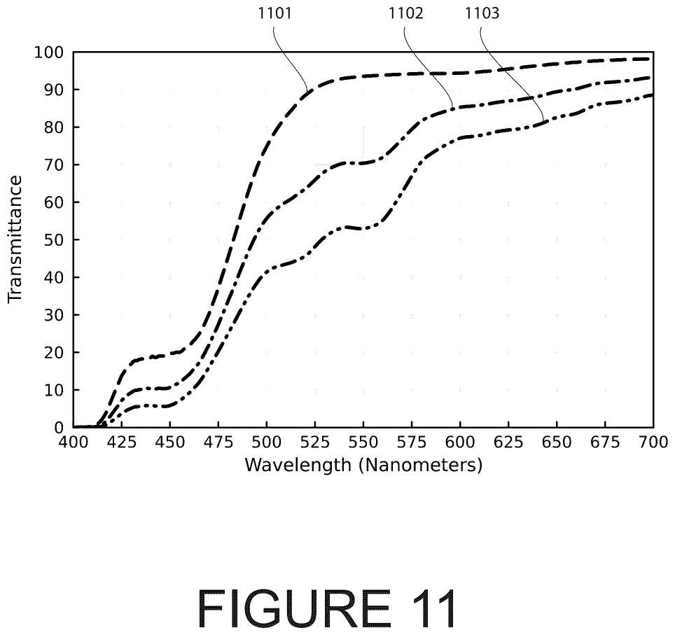

In another example of a preferable eyewear device for nighttime use in accordance with the present invention, the graph of FIG. 11 shows the spectral transmittance of a lens having a gradiently-disposed light attenuating material, for example as depicted in the drawing of FIG. 1, wherein the spectral transmittance of the lenses in the upper portion of the lens is shown by the dot-dot-dashed curve at 1103, and the spectral transmittance of the lenses in the middle portion of the lens is shown by the dot-dashed curve at 1102, and the spectral transmittance of the lenses in the lower portion of the lens is shown by the dashed curve at 1101. An eyewear device having such lenses may be preferred for use during nighttime activities when the average surface illumination is not known, or may vary over a potentially wide range that could exceed 1000 lux. The gradient profile as described provides a substantially greater attenuation of circadian blue light in the upper portion of a user's field of view, ensuring effectiveness of the lens in protecting the circadian rhythm from blue light overstimulation at night and attenuating any direct viewing of overhead lights, while also providing an improved luminous transmittance and reduced color distortion in the lower portion of the field of view where the ipRGC cells of the retina corresponding to the lower portion of the field of view have a lower contribution to the entrainment of the circadian system in humans.

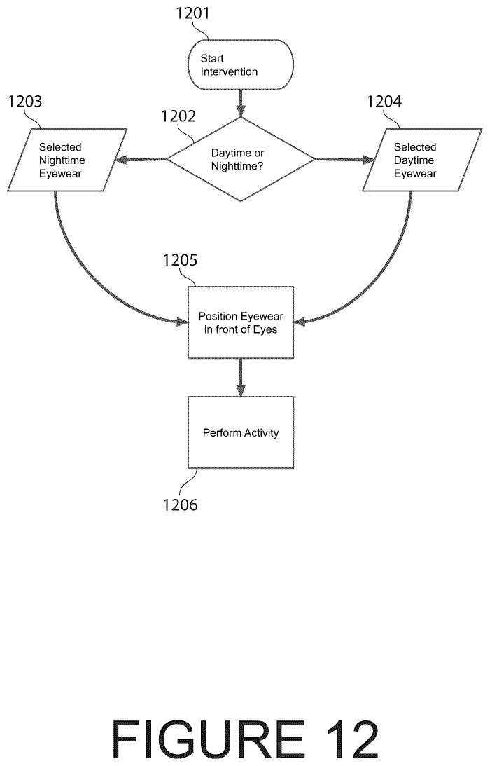

FIG. 12 depicts a process diagram that describes the steps of an embodiment of a method in accordance with the present invention for improving human circadian health (e.g., protecting the circadian system from disruption by excessive exposure to blue light at night, and enhancing the entrainment of the circadian system by providing sufficient exposure to blue light during the day) and protecting the eyes from high-energy visible blue light. The steps of the method begin at 1201 and proceeds to a first decision point at 1202 where we ascertain if the person intends to perform activities during the normal daytime (e.g., 6 AM-6 PM plus or minus 2 hours) or normal nighttime hours (e.g. 6 PM-6 AM plus or minus 2 hours). If the activities are to be performed during daytime hours, then the process proceeds to 1204 where a daytime eyewear device is selected and provided, and then to 1205 where the selected device is positioned in front of the eyes of a person in such a way that the lenses of the selected device substantially filters light received by eyes of the person, and then the person performs said activities at 1206. Alternatively, if the activities are to be performed during nighttime hours, then the process proceeds to 1203 where a nighttime eyewear device is selected and provided, and then to 1205 where the selected device is positioned in front of the eyes of a person in such a way that the lenses of the selected device substantially filters light received by eyes of the person, and then the person performs said activities at 1206. To practice the method, preferably the lenses of the daytime eyewear device are configured such that the mean spectral transmittance between 430 nanometers and 490 nanometers is between 100 percent to 150 percent relative to the luminous transmittance of the lens (or in some variations, greater than 105 percent or greater than 115 percent or greater than 125 percent and less than 150 percent relative to the luminous transmittance of the lenses), and the mean spectral transmittance of the lenses between 400 nanometers to 430 nanometers is less than 40 percent (or in some variations, less than 25 percent, or less than 5 percent, or less than 1 percent). Furthermore, to practice the method, preferably the lenses of the nighttime eyewear device are configured such that the mean spectral transmittance between 430 nanometers and 490 nanometers is less than 40 percent relative to the luminous transmittance of the lenses (or, in some variations is less than 15 percent or is less than 5 percent relative to the luminous transmittance of the lenses). Examples of lenses for daytime eyewear devices include those described in FIG. 3, FIG. 4, FIG. 5, FIG. 6, FIG. 7, and FIG. 8. Examples of lenses for nighttime eyewear devices include those described in FIG. 9, FIG. 10 and FIG. 11.

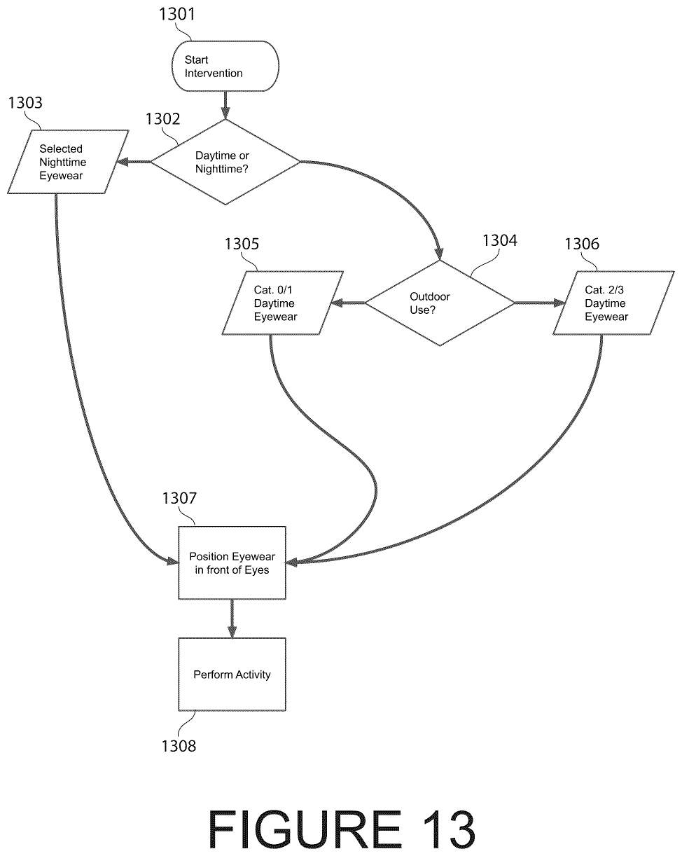

FIG. 13 depicts a process diagram that describes the steps of another embodiment of a method in accordance with the present invention for improving human circadian health (e.g., protecting the circadian system from disruption by excessive exposure to blue light at night, and enhancing the entrainment of the circadian system by providing sufficient exposure to blue light during the day) and protecting the eyes from high-energy visible blue light. The steps of the method begin at 1301 and proceeds to a first decision point at 1302 where we ascertain if the person intends to perform activities during the normal daytime (e.g., 6 AM-6 PM plus or minus 2 hours) or normal nighttime hours (e.g. 6 PM-6 AM plus or minus 2 hours). If the activities are to be performed during daytime hours, then the process proceeds to a second decision point at 1304 where we ascertain if the person intends to perform activities outdoors (e.g. under illumination by sunlight) or indoors. If the activities are to be performed outdoors, the method proceeds to 1306 where a suitable daytime eyewear device is selected and provided which has a Category 2 or Category 3 lenses (i.e., a sunglass eyewear device), and proceeds to 1307 where the selected device is positioned in front of the eyes of a person in such a way that the lenses of the selected device substantially filters light received by eyes of the person, and then the person performs said activities at 1308. Alternatively, if the activities are to be performed substantially indoors, the method proceeds to 1305 where a suitable daytime eyewear device is selected having Category 0 (zero) or Category 1 lenses, which is then positioned in front of the eyes of the person 1307 while they perform the activity 1308. Alternatively, if the activities are to be performed during nighttime hours, then the process proceeds to 1303 where a nighttime eyewear device is selected and provided, and then to 1307 where the selected device is positioned in front of the eyes of a person in such a way that the lenses of the selected device substantially filters light received by eyes of the person, and then the person performs said activity at 1308. To practice the method, preferably the lenses of the daytime eyewear device are configured such that the mean spectral transmittance between 430 nanometers and 490 nanometers is between 100 percent to 150 percent relative to the luminous transmittance of the lens (or in some variations, greater than 105 percent or greater than 115 percent or greater than 125 percent and less than 150 percent relative to the luminous transmittance of the lenses), and the mean spectral transmittance of the lenses between 400 nanometers to 430 nanometers is less than 40 percent relative to the luminous transmittance of the lenses (or in some variations, less than 25 percent, or less than 5 percent, or less than 1 percent relative to the luminous transmittance of the lenses). Examples of lenses for daytime eyewear device for outdoor use include those described in FIG. 6, FIG. 7, and FIG. 8. Examples of lenses for daytime eyewear device for primarily indoor-based activities include those described in FIG. 3, FIG. 4, and FIG. 5. Furthermore, to practice the method, preferably the lenses of the nighttime eyewear device are configured such that the mean spectral transmittance between 430 nanometers and 490 nanometers is less than 40 percent relative to the luminous transmittance of the lenses (or, in some variations is less than 15 percent or is less than 5 percent relative to the luminous transmittance of the lenses). Examples of lenses for nighttime eyewear devices include those described in FIG. 9, FIG. 10 and FIG. 11.

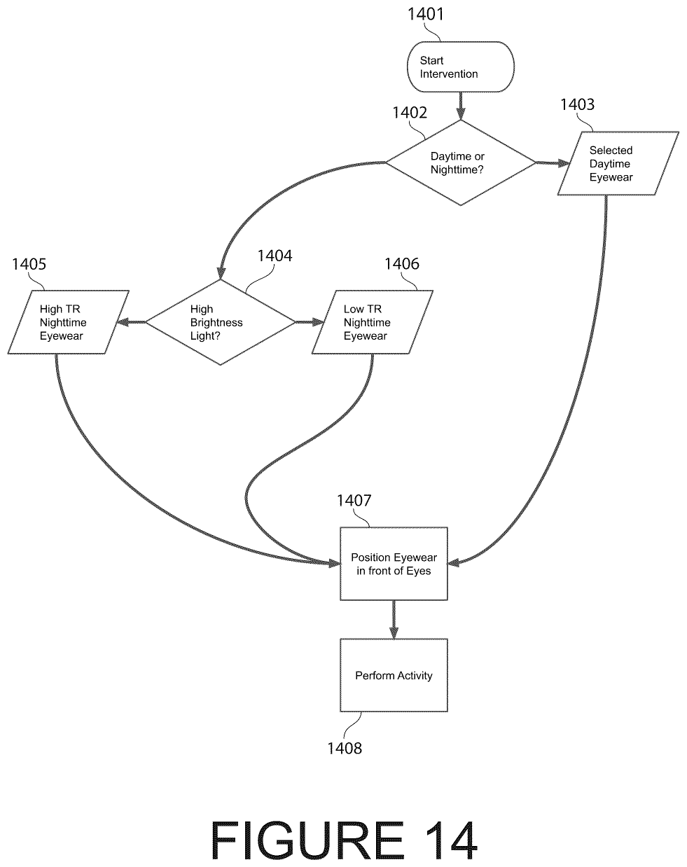

FIG. 14 depicts a process diagram that describes the steps of another embodiment of a method in accordance with the present invention for improving human circadian health (e.g., protecting the circadian system from disruption by excessive exposure to blue light at night, and enhancing the entrainment of the circadian system by providing sufficient exposure to blue light during the day) and protecting the eyes from high-energy visible blue light. The steps of the method begin at 1401 and proceeds to a first decision point at 1402 where we ascertain if the person intends to perform activities during the normal daytime (e.g., 6 AM-6 PM plus or minus 2 hours) or normal nighttime hours (e.g. 6 PM-6 AM plus or minus 2 hours). If the activities are to be performed during nighttime hours, then the process proceeds to a second decision point at 1404 where we ascertain if the person intends to perform the activity under low-level of average surface illumination (e.g. between 100 to 1000 lux) or under high-level of average surface illumination (e.g. between 1000 lux to 10000 lux or greater). If the activities are to be performed under low-level of average surface illumination, the method proceeds to 1405 where a suitable nighttime eyewear device is selected and provided wherein the lenses have a Category 0 or Category 1 luminous transmittance rating and the mean spectral transmittance between 430 nanometer to 490 nanometers is between 25 percent to 40 percent relative to the luminous transmittance of the lenses, for example as described in FIG. 9. Alternatively, if the activities are to be performed under a high-level of average surface illumination, the method proceeds to 1406 where a suitable nighttime eyewear device is selected and provided wherein the lenses have a Category 1 or Category 2 luminous transmittance rating and the mean spectral transmittance between 430 nanometer to 490 nanometer is less than 15 percent relative to the luminous transmittance of the lenses, for example as described in FIG. 10. After a suitable nighttime eyewear device is selected via 1405 or 1406 the selected device is then positioned in front of the eyes of the person 1407 and they then perform the activity 1408. Alternatively, if the activity is to be performed during daytime hours, a suitable daytime eyewear device is selected at 1403 and then positioned in front of the eyes of the person 1407 while they perform the activity 1408. To practice the method, preferably the lenses of the daytime eyewear device is configured such that the mean spectral transmittance between 430 nanometers and 490 nanometers is between 100 percent to 150 percent relative to the luminous transmittance of the lens (or in some variations, greater than 105 percent or greater than 115 percent or greater than 125 percent and less than 150 percent relative to the luminous transmittance of the lenses), and the mean spectral transmittance of the lenses between 400 nanometers to 430 nanometers is less than 40 percent (or in some variations, less than 25 percent, or less than 5 percent, or less than 1 percent). Examples of lenses for daytime eyewear device include those described in FIG. 3, FIG. 4, FIG. 5, FIG. 6, FIG. 7, and FIG. 8.

In some embodiments of a method of in accordance with the present invention for improving human circadian health (e.g., protecting the circadian system from disruption by excessive exposure to blue light at night, and enhancing the entrainment of the circadian system by providing sufficient exposure to blue light during the day) and protecting the eyes from high-energy visible blue light, the method may comprise the secondary decision points of the process in FIG. 14 and of FIG. 13, e.g. selecting suitable nighttime and daytime eyewear devices from a set of four or more devices: two choices for nighttime use in high- and low-surface illumination conditions and among two or more choices for lens tint for indoor or outdoor use during daytime hours. Such a method may be preferable in that it optimizes the user experience in wide variety of lighting conditions. In some embodiments it may be preferable to have only two eyewear devices: one for nighttime use and one for daytime use, and the eyewear devices each comprise gradiently-distributed light attenuating materials, which may be preferable because it reduces the number of distinct eyewear devices that must be maintained and managed by a person, without sacrificing the efficacy of the devices across a wide range of lighting conditions.

In some embodiments of a method of in accordance with the present invention for improving human circadian health (e.g., protecting the circadian system from disruption by excessive exposure to blue light at night), it is preferable to provide a limited collection of eyewear devices that address the needs for blue-light regulation during nighttime hours without also including eyewear devices optimized for use with daytime activities, whereas exposure to circadian blue light at night may have a greater health consequence and due to economic or practical constraints it may not be feasible to provide a complete set of eyewear devices for both daytime and nighttime use. Accordingly, in some variations of the methods described previously, for example as in FIG. 12 or FIG. 14, the methods may be modified to remove the initial daytime-nighttime decision point while retaining subsequent decision points if applicable. In the most simplified form of the method, a single eyewear device for nighttime use may be configured with a gradient profile as described in FIG. 11, whereas such a device would have the broadest applicability to various lighting conditions. Alternatively, two separate eyewear devices for nighttime use can be provided to address high-brightness and low-brightness lighting conditions, for example as described in FIG. 9 and FIG. 10.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object or between objects.

In addition, reference to “first,” “second,” “third,” and etc. members throughout the disclosure (and in particular, claims) are not used to show a serial or numerical limitation but instead are used to distinguish or identify the various members of the group.

Calculations required to implement any of the manufacturing and/or design methods disclosed herein and/or sub-processes within any such methods may be performed, for example, on a computer having 3.2 GHz 6-Core Intel Core i7 processor and 64 GB of RAM using the open source Julia programming language. Spectrophotometric measurements may be performed, for example, using an Ocean Optics USB4000 spectrophotometer and collected using the Ocean View application available from Ocean Optics, Inc. It should be understood by those of ordinary skill in the art that the methods disclosed herein are not limited to the above implementation hardware and/or software elements and are independent of the aforementioned computer and/or system architecture. Accordingly, the methods may equally be implemented on other computing platforms, use other computational software (whether commercially available or coded specifically for the filter design methods), and also may be hard-wired into a circuit or other computational component.

What is claimed is:

1. A method of improving human circadian health and protecting the eyes from high-energy visible blue light comprising:
providing one or more daytime eyewear devices and one or more nighttime eyewear devices, each eyewear device of the one or more daytime eyewear devices and the one or more nighttime eyewear devices having lenses,
selecting and then positioning one of the daytime eyewear devices or one of the nighttime eyewear devices proximally to the eyes of a person in such a way that the lenses of the selected daytime eyewear device or the selected nighttime eyewear device substantially filters light received by the eyes of the person, and
the person performing one or more activities using their sense of vision, wherein,
one of the daytime eyewear devices is selected when the activities are performed substantially during normal daytime hours, and
one of the nighttime eyewear devices is selected when the activities are performed substantially during normal nighttime hours, and
the lenses of the daytime eyewear devices are configured such that the mean spectral transmittance between 430 nanometers and 490 nanometers is between 100 percent to 150 percent relative to the luminous transmittance of the lenses, and the mean spectral transmittance of the lenses between 400 nanometers to 430 nanometers is less than 40 percent relative to the luminous transmittance of the lenses, and
the lenses of the nighttime eyewear devices are configured such that the mean spectral transmittance between 430 nanometers and 490 nanometers is less than 40 percent relative to the luminous transmittance of the lenses.

2. The method of claim 1, wherein the lenses of the selected daytime eyewear device are configured such that the spectral transmittance of the lenses comprises a selective yellow-absorbing notch with a peak absorptance wavelength between 575 nanometers to 600 nanometers and a full-width half-maximum notch-width between 10 nanometers to 25 nanometers and a minimum spectral transmittance less than 80 percent of the luminous transmittance of the lenses and the luminous transmittance of the lenses is greater than 80 percent.

3. The method of claim 1, wherein the lenses of the selected daytime eyewear device are configured such that the mean spectral transmittance between 430 nanometers and 490 nanometers is between 125 percent to 150 percent relative to the luminous transmittance of the lenses and the mean spectral transmittance between 400 nanometers to 430 nanometers is less than 5 percent and the luminous transmittance of the lenses is between 10 percent to 35 percent.

4. The method of claim 1, wherein the lenses of the selected daytime eyewear device are configured such that the mean spectral transmittance between 400 nanometers to 430 nanometers is less than 5 percent and the spectral transmittance comprises a dual-notch structure whereby a first narrow-band notch has a center wavelength between 480 nanometers to 500 nanometers and a full-width half-maximum notch width of between 10 nanometers to 40 nanometers, and a second narrow-band notch has a center wavelength between 565 nanometers to 600 nanometers and a full-width half-maximum notch width of between 10 nanometers to 40 nanometers.

5. The method of claim 1, wherein if the activity is to be performed during daytime hours in the outdoors under natural daylight then the lenses of the selected eyewear device are configured to have a luminous transmittance that is less than 40 percent, and if the activity is to be performed during daytime hours indoors then the lenses of the selected eyewear device are configured to have a luminous transmittance that is greater than 75 percent.

6. The method of claim 1, wherein if the activity is to be performed during daytime hours in both the outdoors under natural daylight and the indoors then the lenses of the selected eyewear device are configured to comprise a photochromic dye such that the luminous transmittance in the darkened state is less than 40 percent, and the luminous transmittance in the faded state is greater than 75 percent, and the mean spectral transmittance between 430 nanometers to 490 nanometers is greater than 100 percent relative to the luminous transmittance in both the faded state and the darkened state.

7. The method of claim 1, wherein if the activity is to be performed during nighttime hours under ambient lighting conditions between 100 lux to 1000 lux then the lenses of the selected eyewear device are configured such that the mean spectral transmittance between 430 nanometers to 490 nanometers is between 25 percent to 40 percent relative to the luminous transmittance of the lenses, and if the activity is to be performed during nighttime hours under ambient lighting conditions between 1000 lux to 10000 lux or greater then the lenses of the selected eyewear device are configured such that thed mean spectral transmittance between 430 nanometers to 490 nanometers is less than 15 percent relative to the luminous transmittance of the lenses.

8. The method of claim 2, wherein if the activity is to be performed during nighttime hours under ambient lighting conditions between 100 lux to 1000 lux then the lenses of the selected eyewear device are configured such that the mean spectral transmittance between 430 nanometers to 490 nanometers is between 25 percent to 40 percent relative to the luminous transmittance of the lenses, and if the activity is to be performed during nighttime hours under ambient lighting conditions between 1000 lux to 10000 lux or greater then the lenses of the selected eyewear device are configured such that the mean spectral transmittance between 430 nanometers to 490 nanometers is less than 15 percent relative to the luminous transmittance of the lenses.

9. The method of claim 3, wherein if the activity is to be performed during nighttime hours under ambient lighting conditions between 100 lux to 1000 lux then the lenses of the selected eyewear device are configured such that the mean spectral transmittance between 430 nanometers to 490 nanometers is between 25 percent to 40 percent relative to the luminous transmittance of the lenses, and if the activity is to be performed during nighttime hours under ambient lighting conditions between 1000 lux to 10000 lux or greater then the lenses of the selected eyewear device are configured such that the mean spectral transmittance between 430 nanometers to 490 nanometers is less than 15 percent relative to the luminous transmittance of the lenses.

10. The method of claim 4, wherein if the activity is to be performed during nighttime hours under ambient lighting conditions between 100 lux to 1000 lux then the lenses of the selected eyewear device are configured such that the mean spectral transmittance between 430 nanometers to 490 nanometers is between 25 percent to 40 percent relative to the luminous transmittance of the lenses, and if the activity is to be performed during nighttime hours under ambient lighting conditions between 1000 lux to 10000 lux or greater then the lenses of the selected eyewear device are configured such that the mean spectral transmittance between 430 nanometers to 490 nanometers is less than 15 percent relative to the luminous transmittance of the lenses.

11. The method of claim 5, wherein if the activity is to be performed during nighttime hours under ambient lighting conditions between 100 lux to 1000 lux then the lenses of the selected eyewear device are configured such that the mean spectral transmittance between 430 nanometers to 490 nanometers is between 25 percent to 40 percent relative to the luminous transmittance of the lenses, and if the activity is to be performed during nighttime hours under ambient lighting conditions between 1000 lux to 10000 lux or greater then the lenses of the selected eyewear device are configured such that the mean spectral transmittance between 430 nanometers to 490 nanometers is less than 15 percent relative to the luminous transmittance of the lenses.

12. The method of claim 6, wherein if the activity is to be performed during nighttime hours under ambient lighting conditions between 100 lux to 1000 lux then the lenses of the selected eyewear device are configured such that the mean spectral transmittance between 430 nanometers to 490 nanometers is between 25 percent to 40 percent relative to the luminous transmittance of the lenses, and if the activity is to be performed during nighttime hours under ambient lighting conditions between 1000 lux to 10000 lux or greater then the lenses of the selected eyewear device are configured such that the mean spectral transmittance between 430 nanometers to 490 nanometers is less than 15 percent relative to the luminous transmittance of the lenses.

13. The method of claim 1, wherein the lenses of the selected eyewear device for use during nighttime hours are configured with a gradient profile wherein the mean spectral transmittance between 430 nanometers to 490 nanometers is between 25 percent to 40 percent relative to the luminous transmittance of the lenses at a location in the lower portion of the lenses, and the mean spectral transmittance between 430 nanometers to 490 nanometers is less than 15 percent relative to the luminous transmittance of the lenses at a location in the upper portion of the lenses.

14. The method of claim 2, wherein the lenses of the selected eyewear device for use during nighttime hours are configured with a gradient profile wherein the mean spectral transmittance between 430 nanometers to 490 nanometers is between 25 percent to 40 percent relative to the luminous transmittance of the lenses at a location in the lower portion of the lenses, and the mean spectral transmittance between 430 nanometers to 490 nanometers is less than 15 percent relative to the luminous transmittance of the lenses at a location in the upper portion of the lenses.

15. The method of claim 3, wherein the lenses of the selected eyewear device for use during nighttime hours are configured with a gradient profile wherein the mean spectral transmittance between 430 nanometers to 490 nanometers is between 25 percent to 40 percent relative to the luminous transmittance of the lenses at a location in the lower portion of the lenses, and the mean spectral transmittance between 430 nanometers to 490 nanometers is less than 15 percent relative to the luminous transmittance of the lenses at a location in the upper portion of the lenses.

16. The method of claim 4, wherein the lenses of the selected eyewear device for use during nighttime hours are configured with a gradient profile wherein the mean spectral transmittance between 430 nanometers to 490 nanometers is between 25 percent to 40 percent relative to the luminous transmittance of the lenses at a location in the lower portion of the lenses, and the mean spectral transmittance between 430 nanometers to 490 nanometers is less than 15 percent relative to the luminous transmittance of the lenses at a location in the upper portion of the lenses.

17. The method of claim 5, wherein the lenses of the selected eyewear device for use during nighttime hours are configured with a gradient profile wherein the mean spectral transmittance between 430 nanometers to 490 nanometers is between 25 percent to 40 percent relative to the luminous transmittance of the lenses at a location in the lower portion of the lenses, and the mean spectral transmittance between 430 nanometers to 490 nanometers is less than 15 percent relative to the luminous transmittance of the lenses at a location in the upper portion of the lenses.

18. The method of claim 6, wherein the lenses of the selected eyewear device for use during nighttime hours are configured with a gradient profile wherein the mean spectral transmittance between 430 nanometers to 490 nanometers is between 25 percent to 40 percent relative to the luminous transmittance of the lenses at a location in the lower portion of the lenses, and the mean spectral transmittance between 430 nanometers to 490 nanometers is less than 15 percent relative to the luminous transmittance of the lenses at a location in the upper portion of the lenses.

19. A method of improving human circadian health comprising:
providing one or more nighttime eyewear devices, each eyewear device of the one or more nighttime eyewear devices having lenses,
selecting and then positioning one of the nighttime eyewear devices proximally to the eyes of a person in such a way that the lenses of the selected nighttime eyewear device substantially filters light received by the eyes of the person;
the person performing one or more activities using their sense of vision, wherein,
one of the nighttime eyewear devices is selected when the activities are performed substantially during normal nighttime hours, wherein
if the activity is to be performed during nighttime hours under ambient lighting conditions between 100 lux to 1000 lux then the lenses of the selected eyewear device are configured such that the mean spectral transmittance between 430 nanometers to 490 nanometers is between 25 percent to 40 percent relative to the luminous transmittance of the lenses, and
if the activity is to be performed during nighttime hours under ambient lighting conditions between
1000 lux to 10000 lux or greater than the lenses of the selected eyewear device are configured such that the mean spectral transmittance between 430 nanometers to 490 nanometers is less than 15 percent relative to the luminous transmittance of the lenses.

20. A method of improving human circadian health comprising:
providing a nighttime eyewear device, the nighttime eyewear device having lenses,
positioning the nighttime eyewear device proximally to the eyes of a person in such a way that the lenses of the selected nighttime eyewear device substantially filters light received by the eyes of the person, and
the person performing one or more activities using their sense of vision, wherein,
the activities are performed substantially during normal nighttime hours, and
the lenses of the eyewear device are configured with a gradient profile wherein the mean spectral transmittance between 430 nanometers to 490 nanometers is between 25 percent to 40 percent relative to the luminous transmittance of the lenses at a location in the lower portion of the lenses, and the mean spectral transmittance between 430 nanometers to 490 nanometers is less than 15 percent relative to the luminous transmittance of the lenses at a location in the upper portion of the lenses.
